(19) United States
(12) Patent Application Publication
(10) Pub. No.: US 2013/0186103 A1
(43) Pub. Date: Jul. 25, 2013

(54) NEAR FLOW PATH SEAL FOR A TURBOMACHINE

(71) Applicants: Sanjeev Kumar Jha, Bangalore (IN); Harish Bommonakatte, Bangalore (IN); Sheo Narain Giri, Bangalore (IN)

(72) Inventors: Sanjeev Kumar Jha, Bangalore (IN); Harish Bommonakatte, Bangalore (IN); Sheo Narain Giri, Bangalore (IN)

(73) Assignee: GENERAL ELECTRIC COMPANY, Schenectady, NY (US)

(21) Appl. No.: 13/354,625

(22) Filed: Jan. 20, 2012

(51) Int. Cl. F02C 7/28; F16J 15/44

(52) U.S. Cl. 60/796; 277/409

(57) ABSTRACT

A near flow path seal for a turbomachine includes a support member having a first end portion that extends to a second end portion through an intermediate portion, and an arm member extending from the first end portion of the support member. The arm member includes a first end that extends to a second end, a first surface extending between the first and second ends, and a second, opposing surface extending between the first and second ends. The second surface includes a plurality of surface features that extend from about the first end toward the second end.

### BACKGROUND OF THE INVENTION

The subject matter disclosed herein relates to the art of turbomachines and, more particularly, to a near flow path seal for a turbomachine.

Turbomachines include a casing that houses a turbine. The turbine includes a plurality of blades or buckets that extend along a gas path. The buckets are supported by a number of turbine rotors that define a plurality of turbine stages. A combustor assembly generates hot gases that are passed through a transition piece toward the plurality of turbine stages. In addition to hot gases from the combustor assembly, lower temperature gases flow from a compressor toward a wheelspace of the turbine. The lower temperature gases provide cooling for the rotors as well as other internal components of the turbine. In order to prevent hot gases from entering the wheelspace, the turbine includes near flow path seals that are arranged between adjacent rotors. The near flow path seals are configured to fit closely adjacent the rotors to reduce leakage from the gas path into the wheelspace.

### BRIEF DESCRIPTION OF THE INVENTION

According to one aspect of the exemplary embodiment, a near flow path seal for a turbomachine includes a support member having a first end portion that extends to a second end portion through an intermediate portion, and an arm member extending from the first end portion of the support member. The arm member includes a first end that extends to a second end, a first surface extending between the first and second ends, and a second, opposing surface extending between the first and second ends. The second surface includes a plurality of surface features that extend from about the first end toward the second end.

According to another aspect of the exemplary embodiment, a turbomachine includes a compressor portion, a turbine portion mechanically linked to the compressor portion, a combustor assembly fluidly connecting the compressor portion and the turbine portion, and a near flow path seal arranged in the turbine portion. The near flow path seal includes a support member having a first end portion that extends to a second end portion through an intermediate portion, and an arm member extending from the first end portion of the support member. The arm member includes a first end that extends to a second end, a first surface extending between the first and second ends, and a second, opposing surface extending between the first and second ends. The second surface includes a plurality of surface features that extend from about the first end toward the second end.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a turbomachine including a near flow path seal in accordance with an exemplary embodiment;

FIG. 2 is a cross-sectional side view of a turbine portion of the turbomachine of FIG. 1 illustrating near flow path seals in accordance with the exemplary embodiment;

FIG. 3 is a perspective view of a near flow path seals in accordance with an exemplary embodiment;

FIG. 4 is a cross-sectional view of an arm member of the near flow path seal of FIG. 3 illustrating a plurality of surface features in accordance with one aspect of the exemplary embodiment;

FIG. 5 is a cross-sectional view of an arm member of the near flow path seal of FIG. 3 illustrating a plurality of surface features in accordance with another aspect of the exemplary embodiment; and

FIG. 6 is a perspective view of a near flow path seal in accordance with another aspect of the exemplary embodiment.

The detailed description explains embodiments of the invention, together with advantages and features, by way of example with reference to the drawings.

### DETAILED DESCRIPTION OF THE INVENTION

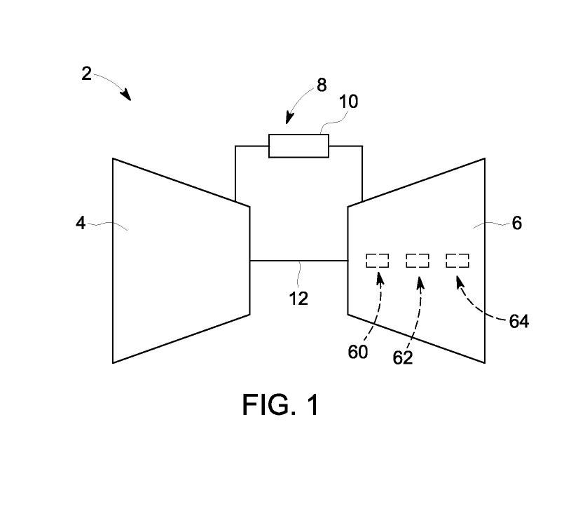

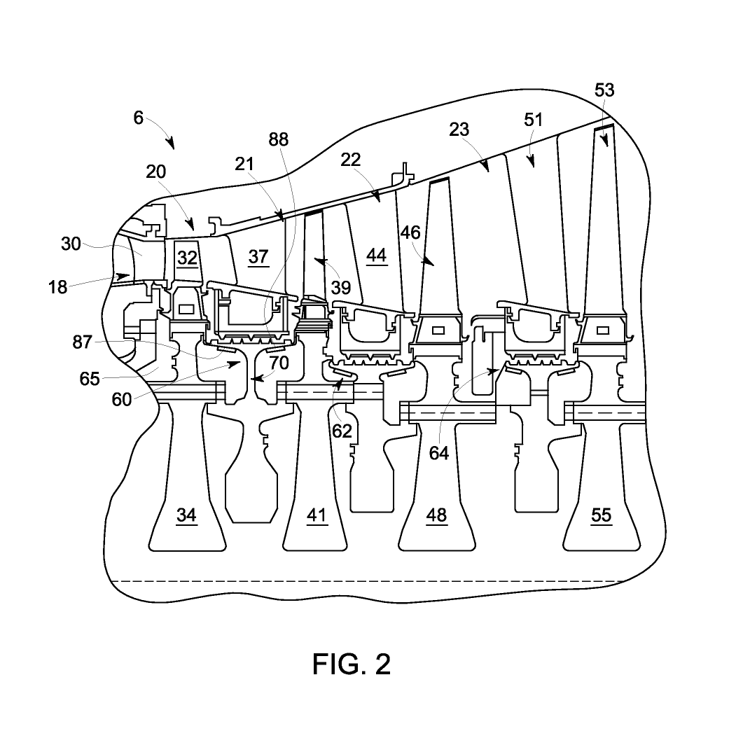

With reference to FIGS. 1 and 2, a turbomachine constructed in accordance with an exemplary embodiment is indicated generally at 2. Turbomachine 2 includes a compressor portion 4 operatively connected to a turbine portion 6. A combustor assembly 8 is fluidly connected to compressor portion 4 and turbine portion 6. Combustor assembly 8 is formed from a plurality of circumferentially spaced combustors, one of which is indicated at 10. Of course it should be understood that combustor assembly 8 could include other arrangements of combustors. Compressor portion 4 is also linked to turbine portion 6 through a common compressor/turbine shaft 12. With this arrangement, compressor portion 4 delivers compressed air to combustor assembly 8. The compressed air mixes with a combustible fluid to form a combustible mixture. The combustible mixture is combusted in combustor 10 to form products of combustion that are delivered to turbine portion 6 through a transition piece (not shown). The products of combustion expand through turbine portion 6 to power, for example, a generator, a pump, an aircraft or the like (also not shown).

In the exemplary embodiment shown, turbine portion 6 includes first, second, third, and fourth stages 20, 21, 22 and 23 that define gas path 18. Of course it should be understood that the number of stages in turbine portion 6 could vary. First stage 20 includes a plurality of first stage stators or nozzles, one of which is indicated at 30, and a plurality of first stage buckets or blades, one of which is indicated at 32, mounted to a first stage rotor wheel 34. Second stage 21 includes a plurality of second stage stators or nozzles, one of which is indicated at 37, and a plurality of second stage buckets or blades, one of which is indicated at 39, mounted to a second stage rotor wheel 41. Third stage 22 includes a plurality of third stage stators or nozzles, one of which is indicated at 44, and a plurality of third stage buckets or blades, one of which is indicated at 46, mounted to a third stage rotor wheel 48. Fourth stage 23 includes a plurality of fourth stage stators or nozzles, one of which is indicated at 51, and a plurality of fourth stage buckets or blades, one of which is indicated at 53, mounted to a fourth stage rotor wheel 55. Turbomachine 2 is also shown to include a plurality of near flow path seal members 60, 62, and 64 arranged between adjacent ones of first, second, third, and fourth stages 20-23. Near flow path seal members 60, 62, and 64 are configured to prevent an exchange of gases between gas path 18 and a wheelspace 65 of turbomachine 2.

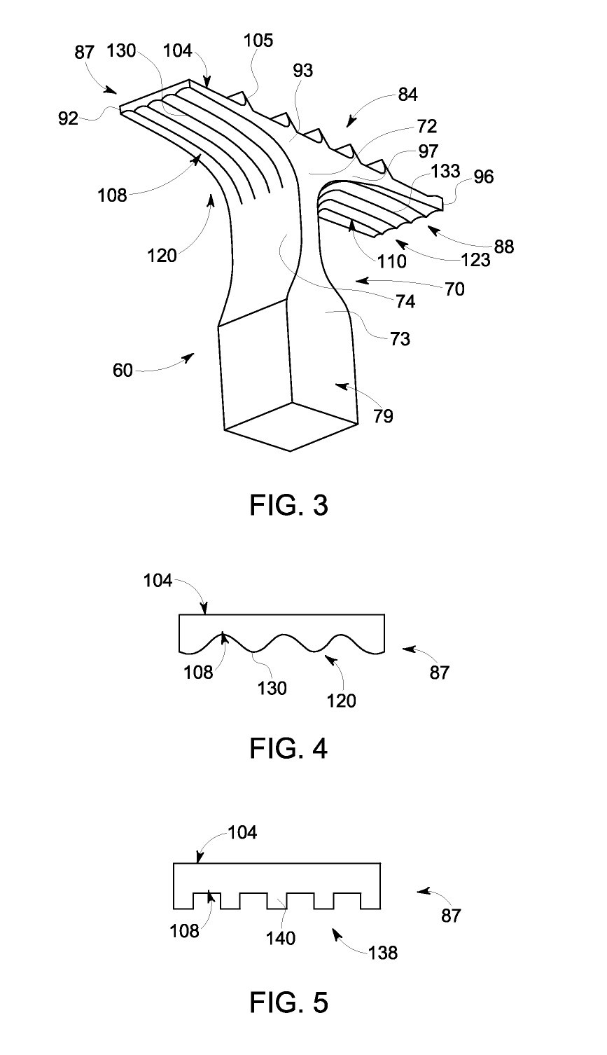

Reference will now be made to FIGS. 3 and 4 in describing near flow path seal member 60 with an understanding that near flow path seal members 62 and 64 may include similar structure. Near flow path seal member 60 includes a support member 70 having a first end portion 72 that extends to a second end portion 73 through an intermediate portion 74. Near flow path seal member 60 includes a dovetail member 79 arranged at second end portion 73 of support member 70, and a sealing member 84 arranged at first end portion 72 of support member 70. Sealing member 84 includes a first arm member 87 and a second, opposing arm member 88. First arm member 87 includes a first or cantilevered end 92 that extends to a second end 93 that joins with first end portion 72 of support member 70. Similarly, second arm member 88 includes a first or cantilevered end 96 that extends to a second end 97 that also joins with first end portion 72 of support arm 70.

Sealing member 84 includes a first surface 104 that extends between first end 92 of first arm member 87 and first end 96 of second arm member 88. First surface 104 constitutes a sealing surface and is exposed to gases flowing along gas path 18. First surface 104 includes a plurality of tooth elements, one of which is indicated at 105. Tooth elements 105 extend at a non-perpendicular angle from first surface 104 to establish a labyrinth seal (not separately labeled) between gases flowing along gas path 18 and gases flowing within wheelspace 65. Sealing member 84 is also shown to include a second surface 108 and a third surface 110. Second and third surfaces 108 and 110 are non-sealing surfaces and are exposed to wheelspace 65. Second surface 108 extends from first end 92 to second end 93 of first arm member 87. Third surface 110 extends from first end 96 to second end 97 of second arm member 88. In accordance with the exemplary embodiment, near flow path seal 60 includes a first plurality of surface features 120 formed on second surface 108 and a second plurality of surface features 123 formed on third surface 110. Surface features 120 and 123 enhance an overall stiffness of first and second arm members 87 and 88 respectively. More specifically, surface features 120 and 123 reduce bending stresses in first and second arm members 87 and 88. The reduction in bending stresses enhances sealing properties of near flow path seal 60.

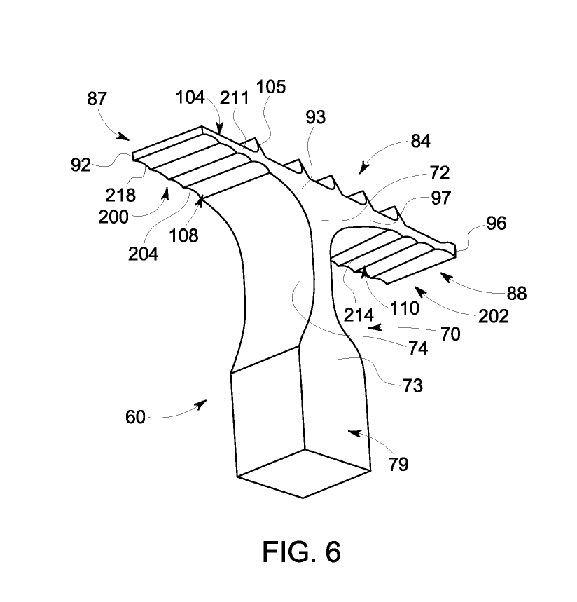

Surface features 120 constitute a first plurality of corrugations or ribs 130 formed on second surface 108. In accordance with one aspect of the exemplary embodiment, ribs 130 extend from first end 92 toward second end 93 and onto intermediate portion 74 of support member 70. Similarly, surface features 123 constitute a second plurality of corrugations or ribs 133 formed on third surface 110. In a manner similar to that previously described, ribs 133 extend from first end 96 to second end 97 and onto intermediate portion 74 of support member 70. In accordance with one aspect of the exemplary embodiment, ribs 130 constitute a plurality of parallel raised ribs having a generally circular cross-section such as shown in FIG. 4. Ribs 133 could be similarly formed or may include a different geometry. Alternatively, near flow path seal member 60 may be provided with a plurality of surface features 138 such as shown in FIG. 5. Surface features 138 constitute corrugations or ribs 140 having a non-circular cross- section. The particular geometry of the surface features could vary and may include honeycombed features. Regardless of shape, it should be understood that the size and number of features could also vary. Near flow path seal member 60 may alternatively be provided with surface features such as shown at 200 and 202 in FIG. 6 where like reference numbers represent corresponding parts in the respective views. Surface features 200 take the form of ribs 204 that extend across second surface 108 between opposing side portions 210 and 211 of sealing member 84. Likewise, surface features 202 take the form of ribs 214 that extend across third surface 110 between opposing side portions 210 and 211. While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A near flow path seal for a turbomachine comprising:
a support member having a first end portion that extends to a second end portion through an intermediate portion; and
an arm member extending from the first end portion of the support member, the arm member including a first end that extends to a second end, a first surface extending between the first and second ends, and a second, opposing surface extending between the first and second ends, the second surface including a plurality of surface features that extend from about the first end toward the second end.

2. The near flow path seal according to claim 1, wherein the plurality of surface features comprise a plurality of ribs formed on the second surface.

3. The near flow path seal according to claim 2, wherein the plurality of ribs comprise a plurality of parallel raised ribs.

4. The near flow path seal according to claim 2, wherein the plurality of ribs include a generally circular cross-section.

5. The near flow path seal according to claim 2, wherein the plurality of ribs include a non-circular cross-section.

6. The near flow path seal according to claim 1, wherein the plurality of surface features extend from about the first end across the second surface and onto the intermediate portion of the support member.

7. The near flow path seal according to claim 1, wherein the second surface is a non-sealing surface.

8. The near flow path seal according to claim 1, wherein the first surface is a sealing surface.

9. The near flow path seal according to claim 8, further comprising: a plurality of tooth elements extending from the sealing surface.

10. The near flow path seal according to claim 9, wherein the plurality of tooth elements extend from the sealing surface at a non-perpendicular angle.

11. The near flow path seal according to claim 1, further comprising: another arm member extending from the first end of the support member, the another arm member including a first end that extends to a second end, and including a plurality of surface features that extend from about the first end toward the second end.

12. A turbomachine comprising:
a compressor portion;
a turbine portion mechanically linked to the compressor portion;
a combustor assembly fluidly connecting the compressor portion and the turbine portion; and
a near flow path seal arranged in the turbine portion, the near flow path seal comprising:
a support member having a first end portion that extends to a second end portion through an intermediate portion; and
an arm member extending from the first end portion of the support member, the arm member including a first end that extends to a second end, a first surface extending between the first and second ends, and a second, opposing surface extending between the first and second ends, the second surface including a plurality of surface features that extend from about the first end toward the second end.

13. The turbomachine according to claim 12, wherein the plurality of surface features comprise a plurality of ribs formed on the second surface.

14. The turbomachine according to claim 13, wherein the plurality of ribs comprise a plurality of parallel raised ribs.

15. The turbomachine according to claim 13, wherein the plurality of ribs include a generally circular cross-section.

16. The turbomachine according to claim 13, wherein the plurality of ribs include a non-circular cross-section.

17. The turbomachine according to claim 12, wherein the plurality of surface features extend from about the first end across the second surface and onto the intermediate portion of the support member.

18. The turbomachine according to claim 12, wherein the second surface is a non-sealing surface.

19. The turbomachine according to claim 12, wherein the first surface is a sealing surface.

20. The turbomachine according to claim 12, further comprising: another arm member extending from the first end of the support member, the another arm member including a first end that extends to a second end, and including a plurality of surface features that extend from about the first end toward the second end.
